(19) United States
(12) Patent Application Publication
(10) Pub. No.: US 2008/0168229 A1
(43) Pub. Date: Jul. 10, 2008

(54) Method of Caching Data Assets

(75) Inventors: Peter Henricus Gerardus Beelen, Eindhoven (NL); Marnix Koerselman, Eindhoven (NL); Markus Martinus Johannes Venbrux, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/568,372

(22) PCT Filed: Aug. 5, 2004
(86) PCT No.: PCT/IB04/51398

§ 371 Date: Feb. 14, 2006

(30) Foreign Application Priority Data
Aug. 19, 2003 (EP) 03102592.7

(51) Int. Cl. G06F 17/30

(52) U.S. Cl. 711/118

(57) ABSTRACT

There is provided a method of caching data assets in a system (10) comprising at least one server (20) and at least one user device (50). Each device (50) includes a cache arrangement (120, 130, 140) comprising a plurality of caches (120, 130, 140) for storing requested data assets therein. The method includes the steps of: (a) arranging for one or more data assets to be stored in a first memory (30) of said at least one server (20) and data definitions corresponding to said one or more data assets in a second memory (40) of said at least one server (20); (b) arranging for said at least one server (20) to be responsive to one or more data requests from said at least one user device (50) by returning to said at least one user device (50) corresponding one or more requested data assets. The one or more requested data assets are provided to said at least one user device (50) with associated data definitions for controlling storage and processing of said one or more requested data assets in said at least one user device (50), said at least one server (20) thereby being operable to at least partially control the cache arrangement (120, 130, 140) in said at least one device (50).

The present invention relates to methods of caching data assets, for example dynamic server pages. Moreover, the invention also relates to systems susceptible to function according to the methods.

Systems comprising servers disposed to provide content to one or more users connected to the servers is well known, for example as occurs in contemporary telecommunication networks such as the Internet. The one or more users are often individuals equipped with personal computers (PC's) coupled via telephone links to one or more of the servers. Moreover, the one or more users are able to obtain information, namely downloading content, from the servers. Downloading of such content typically requires the one or more user transmitting one or more search requests to the one or more servers, receiving search results therefrom and then from the search results selecting one or more specific items of content stored on the one or more servers. If the identity of the one or more specific items is known in advance, the one or more users are capable to requesting content associated with these items directly from the one or more servers.

In order to search for content, a complex series of interactions arises between the one or more users and the one or more servers. For example such searching and subsequent downloading of content often results in substantial amounts of memory being utilized in computing equipment of the one or more users.

The inventors have appreciated that practical data handling problems occur in such a scenario when PC's associated with the one or more users are relatively limited in memory capacity and are therefore unable to store numerous down-loaded pages of content. Such limited memory capacity is especially pertinent in the case of miniature portable computing devices being provided with modest memory capacity.

Such a scenario of limited user device memory capacity is known. For example, in a U.S. Pat. No. 6,418,544, there is described a method involving the use of a client meta-cache for realistic high-level web server stress testing with minimal client footprint; “footprint” in the specification is to be construed to pertain to available client memory capacity. Thus, in the patent no. U.S. Pat. No. 6,418,544, there is described a method, a system utilizing the method and a computer readable code for use in the method for improving stress testing in web servers. In the method, an altered form of client cache is used, enabling more realistic and representative client requests to be issued during the testing process; such an altered cache is known as a “meta-cache”. A definition for a meta cache is as a cache arrange for storing a minimal subset of information that would typically be cached from a response, for example, sent to a server, this minimal subset is that which enables the construction of conditional HyperText Transfer Protocol (HTTP) GET requests. In the method, by providing a capability for realistically simulating conditional requests as well as unconditional requests, stress applied to the server is more representative of actual communication traffic load that the server will experience when in actual on-line operation. The method is arranged to reduce an amount of information stored in such a meta-cache without there being an overhead of a full client cache. Moreover, the method further allows more browsers to be simulated from a particular workstation having limited memory capacity.

Thus, it is known from the patent no. U.S. Pat. No. 6,418,544, for example in the context of the Internet-type networks, to provide one or more servers and a plurality of browsers coupled thereto wherein the browsers are provided with meta-caches.

Moreover, in a published European patent application no. EP 1,061,458, there is described a system and method to cache reduced forms of web pages. Various types of reduction processes are performable in the method to provide such reduced web pages. For example, web pages may comprise elements which are unnecessary to display or are unsupported for particular small print devices, for example in mobile telephones provided with simple graphical pixel screen displays and limited memory capacity. In the method, these elements are susceptible to being removed before a web page is cached, thereby potentially reducing memory space taken in the cache for the reduced pages and hence additionally provide a benefit of reduced time required when rendering the stored reduced pages for view in comparison to rendering and displaying corresponding non-reduced web pages. Moreover, the method also provides for storage of a parse tree used for identifying web pages instead of web pages in text form. Furthermore, the aforementioned European patent application also includes a description of a slender containment framework for software applications and software services executing on such small footprint devices. The slender framework is susceptible to being used to construct a web browser operable to cache reduced form of web pages, the slender framework being suitable for use in small footprint devices such as mobile telephones and palm-top computers.

The inventors have appreciated that contemporary small footprint devices require too much communication bandwidth when implemented using three-tier software applications. Furthermore, when implemented using two-tier software applications, the small footprint devices tend to require inconveniently large amounts of memory capacity to function. Whether implemented using three-tier or two-tier software applications, the inventors have appreciated for such small footprint devices that associated network latency is not acceptable in all situations, for example when switching from screen to screen whilst merely presenting graphical image information.

The inventors have thus devised an alternative method employing meta-caches which is distinguished from methods described in the aforementioned United States and European patent applications.

A first object of the present invention is to provide a method for controlling a cache on a user facility from a server remote therefrom.

A second object of the invention is to provide such a method which is operable to function efficiently in conjunction with small footprint devices.

According to a first aspect of the present invention, there is provided a method of caching data assets in a system comprising at least one server and at least one user device, each device including a cache arrangement comprising a plurality of caches for storing requested data assets therein, the method including the steps of:

(a) arranging for one or more data assets to be stored in a first memory of said at least one server and data definitions corresponding to said one or more data assets in a second memory of said at least one server;
(b) arranging for said at least one server to be responsive to one or more data requests from said at least one user device by returning to said at least one user device corresponding one or more requested data assets,
wherein said one or more requested data assets are provided to said at least one user device with associated data definitions for controlling storage and processing of said one or more requested data assets in said at least one user device, said at least one server thereby being operable to at least partially control the cache arrangement in said at least one device.

The invention is of advantage in that it is capable of providing control of user device cache content from at least one of the servers.

The method is of benefit especially in small foot-print devices where memory capacity is restricted and/or where communication bandwidth is restricted.

Preferably, in the method, said plurality of caches in each user device are operable to store both requested assets and their associated definitions. Inclusion of the definitions is especially desirable as it enables the at least one server to control the cache arrangement of the at least one user device, thereby providing data assets in a form suitable for the at least one user device and storing it efficiently in a more optimal region of the cache arrangement.

Preferably, in the method, said plurality of caches of said cache arrangement are designated to be of mutually different temporal duration, and said definitions associated with said one or more requested data assets are interpretable within said at least one user device to control storage of said one or more requested data assets in appropriate corresponding said plurality of caches. By partitioning the cache arrangement into mutually different temporal duration caches, the at least one server is better able to direct data assets and associated definitions so that operation of the at least one user device is render at least one of more efficient and less memory capacity intensive.

Preferably, in the method, said at least one user device includes:

(a) content managing means for interpreting requests and directing them to said at least one server for enabling said at least one user device to receive corresponding one or more requested data assets; and
(b) cache managing means for directing said one or more requested data assets received from said content managing means to appropriate said plurality of caches depending on said definitions associated with said one or more requested data assets.

Beneficially, at least one of the content managing means and the cache managing means are implemented as one or more software applications executable on computing hardware of said at least one user device.

Preferably, in the method, for each user device, said plurality of caches comprises at least one read-once cache arranged to store one or more requested data assets therein and to subsequently deliver said one or more requested assets a predetermined number of times therefrom after which said one or more requested data assets are deleted from said at least one read-once cache. Such deletion is capable of freeing memory capacity in the user device thereby enabling it to operate more efficiently when provided with limited memory capacity and/or enabling it to provide an apparently greater range of server pages. More preferably, said predetermined number of times corresponds to a single read prior to data asset deletion.

Preferably, each user device further includes interfacing means for interfacing between at least one operator of said at least one user device and at least one of said content managing means and said cache managing means, said interfacing means:

(a) for conveying asset data requests from the operator to said at least one of said content managing means and said cache managing means for subsequent processing therein; and
(b) for rendering and presenting to said at least one operator said requested data assets retrieved from at least one of said cache arrangement and directly from said at least one server.

Beneficially, the interfacing means is implemented as one or more software applications executable on computing hardware of the user device. More preferably, the interfacing means is operable to provide a graphical interface to said at least one operator.

Preferably, in the method, the interfacing means in combination with at least one of said content managing means and said cache managing means is operable to search said cache arrangement for one or more requested assets before seeking such one or more requested assets from said at least one server. Such prioritising is of benefit in that communication bandwidth requirements between the at least one server and at least one user device are potentially thereby reduced. More preferably, in the method, said cache arrangement is firstly searched for said one or more requested assets and subsequently said at least one server is searched when said cache arrangement is devoid of said one or more requested assets.

Preferably, in the method, the cache arrangement is progressively searched from caches with temporally relatively shorter durations to temporally relatively longer durations. Such a searching order is capable of providing more rapid data asset retrieval.

Preferably, in the method, said cache arrangement is preloaded with one or more initial data assets at initial start-up of its associated user device to communicate with said at least one server, said one or more initial data assets being susceptible to being overwritten when said user device is in communication with said at least one server. Use of such pre-loaded assets is capable of providing said at least one device with more appropriate start-up characteristics to its operator.

Preferably, for example to ensure compatibility with the contemporary Internet, in the method, one or more of the data assets are identified by associated universal resource locators (URL).

Preferably, in the method, said system is operable according to first, second and third phases wherein:

(a) the first phase is arranged to provide for data asset entry into said first and second memories of at least one server;
(b) the second phase is arranged to provide for content download from said at least one server to said cache arrangement of at least one user device; and
(c) the third phase is arranged to provide for content retrieval from at least one of said cache arrangement of said at least one user device and from said at least one server.

The use of such distinct phases is capable of enabling the method to function more efficiently to reduce bandwidth requirements and/or memory capacity requirements at the at least one user device.

According to a second aspect of the present invention, there is provided a system for caching data assets, the system comprising at least one server and at least one user device, each device including a cache arrangement comprising a plurality of caches for storing requested data assets therein, the system being arranged to be operable:

(a) to store one or more data assets in a first memory of said at least one server and data definitions corresponding to said one or more data assets in a second memory of said at least one server;
(b) to arrange for said at least one server to be responsive to one or more data requests from said at least one user device by returning to said at least one user device corresponding one or more requested data assets, wherein said one or more requested data assets are provided to said at least one user device with associated data definitions for controlling storage and processing of said one or more requested data assets in said at least one user device, said at least one server thereby being operable to at least partially control the cache arrangement in said at least one device.

It will be appreciated that features of the invention are susceptible to being combined in any combination without departing from the scope of the invention.

Embodiments of the invention will now be described, by way of example only, with reference to the accompanying diagrams wherein:

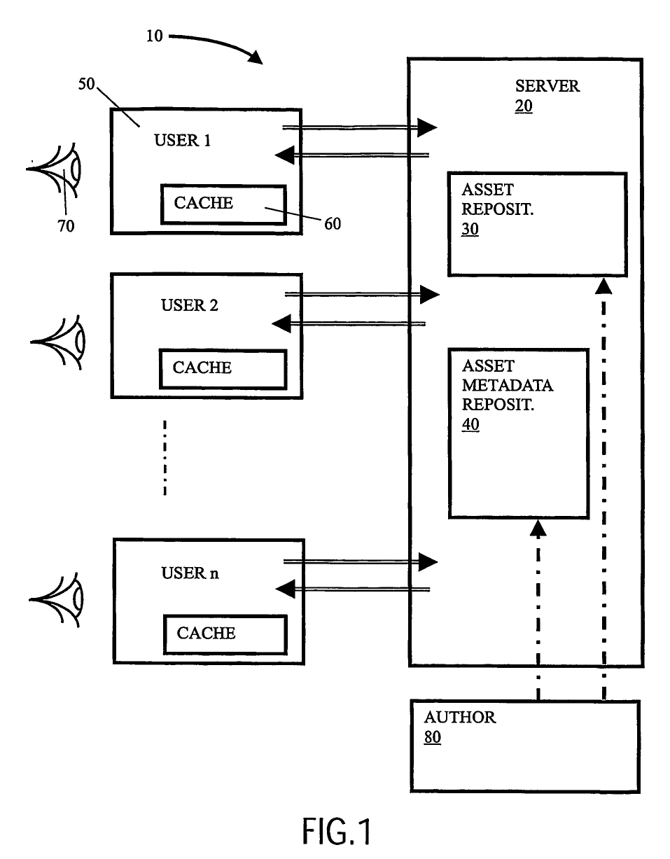

FIG. 1 is a schematic diagram of a system operable according to a method of the present invention, the system comprising a server arranged to receive content from one or more authors, and deliver such content on demand to one or more user devices in communication with the server;

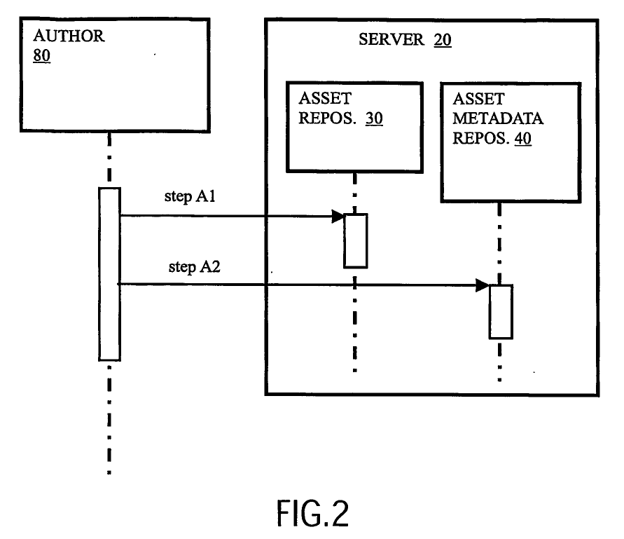

FIG. 2 is a schematic illustration of steps A1 to A2 required for the author of FIG. 1 to load content into the server of FIG. 1;

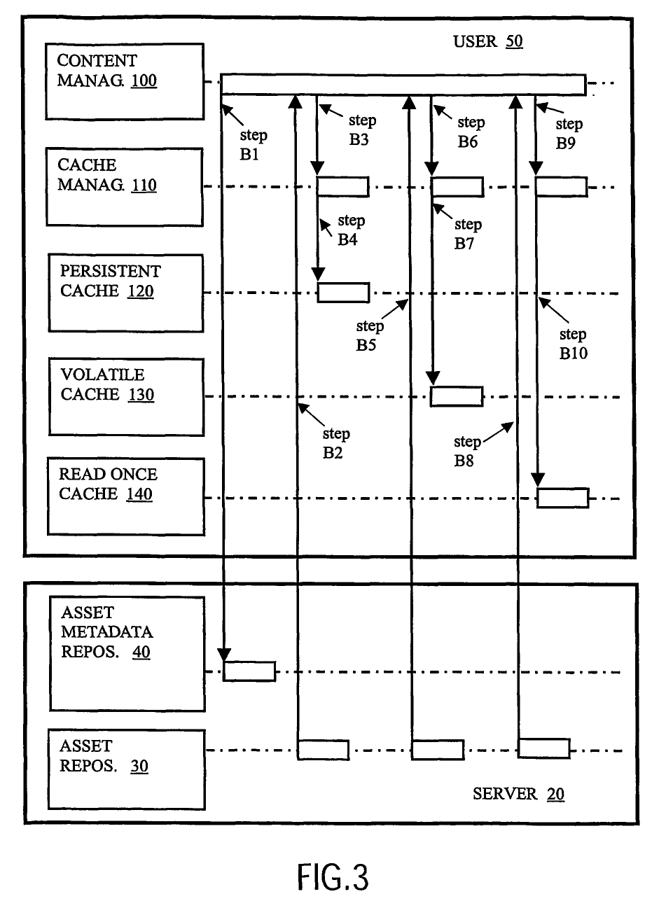

FIG. 3 is a schematic illustration of steps B 1 to B 10 associated with downloading content from the server of FIG. 1 to one of the user devices of FIG. 1; and

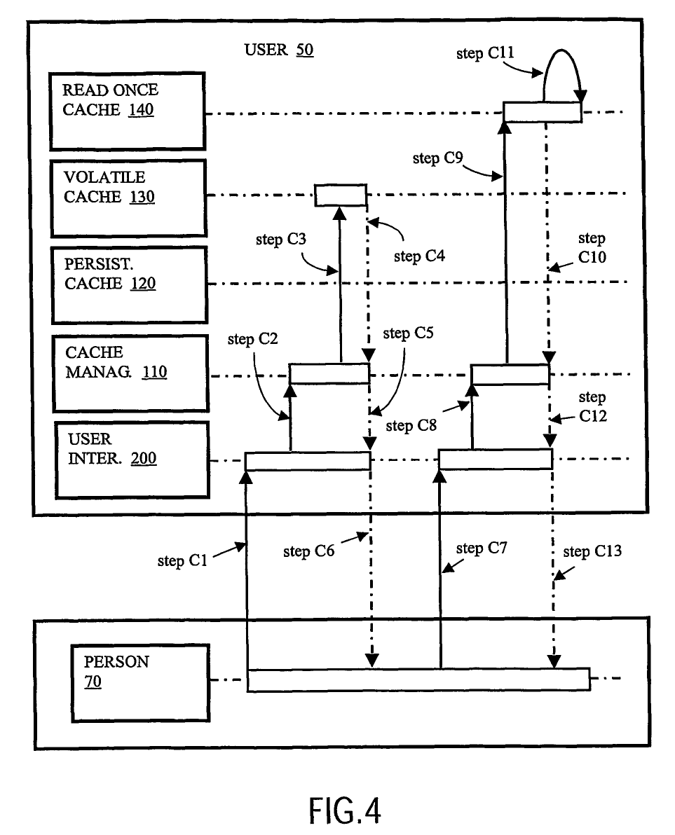

FIG. 4 is a schematic diagram of a user device of FIG. 1 retrieving content with the system illustrated in FIG. 1.

In devising the present invention, the inventors have provided a method capable of at least partially solving server-user interactions in communication networks, for example in the Internet. The method involves the provision of user devices. Each such device includes corresponding caches susceptible to having downloaded thereinto elementary or packaged sets of interface screen contents. Moreover, the caches are capable of never returning failure messages to associated human operators when one or more entries by the human operators expire. Entries from the caches are beneficially provided without checking with regard to associated expiration dates and times.

Embodiments of the invention will now be described with reference to FIGS. 1 to 4.

In FIG. 1, there is shown a communication system indicated generally by 10. The system 10 is operable to communicate digital data therethrough, for example data objects including at least one of HTTP data, image data, software applications and other types of data. Moreover, the system 10 comprises at least one server, for example a server 20. The server 20 includes an asset repository (ASSET REPOSIT.) 30 and an asset metadata repository (ASSET METADATA REPOSIT.) 40. However, the server 20 is susceptible to additionally including other components not explicitly presented in FIG. 1.

The server 20 includes features for interfacing to one or more authors, for example an author 80. The author 80 is, for example, at least one of a private user, a commercial organisation, a government organisation, an advertising agency and a special interest group. Moreover, the author 80 is desirous to provide content to the system 10, for example one or more of text, images, data files and software applications. There are also one or more user devices, namely USER 1 to USER n where a number of user devices is defined by a parameter “n”; for example, there is user device 50 having an associated human operator 70. Each user device includes a metacache 60 as illustrated. The user devices are coupled to one or more of the servers, for example to the server 20, by way of associated bidirectional communication links, for example at least one of wireless links, conventional coax telephone lines and/or wide-bandwidth fibre-optical links.

Operation of the system 10 is subdivided into three phases, namely:

(a) a first phase concerned with content preparation;
(b) a second phase concerned with content download; and
(c) a third phase concerned with content retrieval.

The first phase is executed when defining content in the servers, for example in the server 20. Moreover, the first phase effectively has an associated lifecycle which is dissimilar to the second and third phases.

The second and third phases are often implemented independently. However, the second and third phases are susceptible to being executed in combination. For example, when implemented independently, the second phase is susceptible to being initiated by an electronic timing function, whereas the third phase is always initiated by one of the user devices, for example the user device 50. In contradistinction, when implemented in combination, the second phase is susceptible to being initiated automatically when the human operator 70 requests information from its user device 50 where a desired data object, namely a requested asset, is not is not available in the cache 60 of the user device 50.

The first phase concerned with content preparation will now be described in further details with reference to FIG. 2.

During the first phase, the author 80 prepares user interface assets such as images, sounds and text in the form of data objects; in other words, the author 80 prepares one or more data objects. The author 80 then proceeds to arrange for these assets, namely data objects, to be stored on the server 20 in step A1. Each asset is stored in the asset repository 30 of the server 20. Moreover, one or more definitions of each asset stored is also entered into the asset metadata repository 40 of the server 20 in step A2. During such storage of author 80's assets in the server 20, a caching hint associated with each of the assets is additionally defined and stored in the metadata repository 40, such hints preferably taking into consideration an expected “valid” time for each associated asset stored in the server 20. The “valid” time is susceptible to being defined as:

(a) “persistent”: the asset is unlikely to be amended in the near future. Correspondingly, when one or more of the users are desirous to access one or more assets, the one or more users are required to check using a “slow” rate to determine whether or not the asset has been changed at the server 20. In the system 10, having an old asset, namely having object data corresponding to an older version of an asset which has subsequently been amended and updated, is arranged not to have a catastrophic effect on operation of the system 10 when render and presented, namely the system 10 is capable of coping with older versions of assets being communicated therein as well as corresponding newer versions;
(b) “volatile”: the asset is likely to be changed in response to operating conditions within the system 10. When user devices of the system 10, for example the user device 50, load assets from the server 20 to its cache 60, the user 50 is required to refresh details pertaining to “volatile” assets more rapidly than “persistent” assets; and
(c) “read-once”: the asset is intended to be shown once at a user device, for example to the human operator 70 at the user device 50. Such “read-once” assets are especially pertinent to presenting, for example, error messages and other similar temporary information.

Assets having mutually different definitions are susceptible in the system 10 to being packaged together in one or more archive files. Although, from the users' perspective, such archive files appear as separate individual assets, they are effectively a single entity from a perspective of cache storage thereof.

Thus, the first phase corresponds to asset entry from authors into the servers, such entry involving entering data content in asset repositories 30 of the servers in step A1 as well as entering caching hints and “valid” time into asset metadata repositories 40 in step A2.

The second phase is concerned with content download and will now be described with reference to FIG. 3.

In FIG. 3, three examples of a manner in which assets are transferred from one or more of the servers, for example the server 20, to one or more of the user devices, for example to the user device 50 and its associated human operator 70.

The cache 60 associated with each user device 50 is subdivided into a persistent cache 120, a volatile cache 130 and a read-once cache 140. Moreover, each user device 50 has sufficient memory and associated computational power for executing a content manager software application (CONTENT MANAG.) 100 and cache management software application (CACHE MANAG.) 110 as illustrated.

In a first example, the user device 50 obtains asset information from the server 20 in step B 1; namely, the content manager 100 of the user device 50 is operable, for example in response to receipt of a request from the human operator 70, to send a request for information to the asset metadata repository 40 of the server 20. The user device 50 receives information about one or more assets in response to the request. The step B1 is repeated one or more times by the user device 50 when needed, for example, an electronic timer in the user device 50 or a login by the human operator 70 is susceptible to causing step B1 to be executed and/or re-executed within the system 10. The system 10 as implemented in practice by the inventors uses contemporary HTTP message protocol, for example SOAP message. In step B1, information from the server metadata repository 40 of the server 20 can, if required, be passed to the user device 50 at a later instance instead of substantially immediately in response to the server 20 receiving a request for information; for example, such a later instance corresponds to steps B2, B5 and B8. Next, in step B2, an asset is passed together with its associated caching hint to the content manager 100 which subsequently, in step B3, passes the asset and its hint to the cache manager 110. The cache manager 110 is operable to interpret the hint and selects therefrom in step B4 to store the asset and its hint in the persistent cache 120.

In a second example, the user device 50 obtains asset information from the server 20 in step B1; namely, the content manager 100 of the user 50 is operable, for example in response to receipt of a request from the human operator 70, to send a request for information to the asset metadata repository 40 of the server 20. The user device 50 receives information about one or more assets in response to the request. The step B1 is repeated one or more times by the user device 50 when needed. Next, in step B5, an asset is passed together with its associated caching hint to the content manager 100 which subsequently, in step B6, passes the asset and its hint to the cache manager 110. The cache manager 110 is operable to interpret the hint and selects therefrom to store the asset and its hint in the volatile cache 130.

In a third example, the user device 50 obtains asset information from the server 20 in step B1; namely, the content manager 100 of the user device 50 is operable, for example in response to receipt of a request from the human operator 70, to send a request for information to the asset metadata repository 40 of the server 20. The user device 50 receives information about one or more assets in response to the request. The step B1 is repeated one or more times by the user device 50 when needed. Next, in step B8, an asset is passed together with its associated caching hint to the content manager 100 which subsequently, in step B9, passes the asset and its hint to the cache manager 110. The cache manager 110 is operable to interpret the hint and selects therefrom to store the asset and its hint in the read-once cache 140 of the user device 50.

Thus, the cache manager 110 is operable to store an asset and its associated hint in one of the three caches 120, 130, 140 depending upon the nature of the hint received.

The aforementioned third phase is concerned with content retrieval and will now be described with reference to FIG. 4.

In FIG. 4, the user 50 is shown additionally to include a user interface 200. The interface 200 is preferably implemented in computing hardware of the user device 50 in at least one of hardware and at least one software application. The user interface 200 is operable to interface with the cache manager 110 and thereby retrieve content from one or more of the caches 120, 130, 140 as appropriate.

Assets cached within the caches 120, 130, 140 are predominantly processed, for example rendered for display to the human operator 70, in the user interface 200. However, the assets within the caches 120, 130, 140 are susceptible to being also used elsewhere in the user device 50, for example as input data to other software applications executing within the user device 50.

In FIG. 4, there is shown the operator 70 requesting a page of information. In step C1, the operator 70 sends a request for the page to the user interface 200, for example by moving on a screen of the user device 50 a mouse-like icon over an appropriate graphical symbol and then pressing an enter key providing on an operator-accessible region of the user device 50. The user interface 200 then in step C2 communicates with the cache manager 110 to identify in which of the caches 120, 130, 140 the page is stored, or information stored required to construct the page at the user interface 200. Retrieval in step C2 is beneficially based on standard Universal Resource Locator (URL) syntax although other syntax is susceptible to being additionally or alternatively employed; use of such URL's is based on retrieving content from the caches 120, 130, 140 of the user device 50 and not from the server 20. The cache manager 110 searches the caches 120, 130, 140 is response to the operator 70's request for assets and proceeds to obtain the requested asset from, for example, the volatile cache 130 in step C3. In step C4, the volatile cache 130 sends a reference to the requested asset in return to the cache manager 110, for example an UTRL. Subsequently, in step C5, the cache manager 110 forwards the requested asset to the user interface 200. The interface 200 is operable to manipulate and render the requested asset and then, in step C6, to present the requested asset to the operator 70.

Steps C7 to C13 demonstrate a similar asset retrieval process wherein a page is retrieved from the read-once cache 140. Thus, in step C7, the operator 70 sends a request for the page to the user interface 200, for example by moving on a screen of the user device 50 a mouse-like icon over an appropriate graphical symbol and then pressing an enter key providing on an operator-accessible region of the user device 50. The user interface 200 then in step C8 communicates with the cache manager 110 to identify in which of the caches 120, 130, 140 the page is stored, or information stored required to construct the page at the user interface 200. Retrieval in step C8 is again beneficially based on standard Universal Resource Locator (URL) syntax although other syntax is susceptible to being additionally or alternatively employed; use of such URL's is based on retrieving content from the caches 120, 130, 140 of the user device 50 and not from the server 20. The cache manager 110 searches the caches 120, 130, 140 is response to the operator 70's request for assets and proceeds to obtain the requested asset from, for example, the read-once cache 140 in step C9. In step C10, the read-once cache 140 sends a reference to the requested asset in return to the cache manager 110, for example an URL. Moreover, in step C11, the read-once cache 140 is operable, if necessary in combination with the cache manager 110, to delete the particular page from the read-once cache 140 once a data asset corresponding to the page has been sent in steps C10, C11 from the read-once cache 140 via the cache manager to the user interface 200. Subsequently, in step C12, the cache manager 110 forwards the requested asset to the user interface 200. The interface 200 is operable to manipulate and render the requested asset and then, in step C13, to present the requested asset to the operator 70.

If required, step C11 can be implemented after step C12.

Step C11 is of advantage in that a data asset retrieved therefrom by the cache manager 110 is deleted promptly so that the read-once cache 140's data content is maintained as small as possible. On account of step C11, an attempt to re-access an asset in the read-once cache 140 which has earlier been accessed results in the asset not being located.

Preferably, when searching for a desired asset defined by the human operator 70, the cache manager 110 is operable to search within the caches 120, 130, 140 in an order corresponding to an expected lifetime of the desired asset; such an approach to searching results in potentially faster retrieval of the desired asset. For example, the read-once cache 140 is firstly searched followed secondly by the volatile cache 130 followed thirdly by the persistent cache 120; when the desired asset is located, for searching for the asset in the caches 120, 130, 140 is ceased. The desired asset is preferably defined by an URL or similar label.

In an event that the cache manager 110 is unable to locate a desired asset within the caches 120, 130, 140, the cache manager 110 is operable to return a failure message to the user interface 200. Such return of the failure message is preferably implemented by retrieving another asset, for example from the server 20 and/or from one or more of the caches 120, 130, 140. A URL corresponding to such a failure message is preferably predefined.

The system 10 is capable of being implemented such that pre-loading of certain assets from one or more caches 120, 130, 140 of the user devices, for example in the user device 50, occurs during user device start-up. Such pre-loading is preferably applicable for assets that are needed before any contact with the servers, for example the server 20, to download assets therefrom. Moreover, the system 10 is preferably arranged so that the pre-loaded assets are susceptible to being overwritten once communication with one or more of the servers is achieved.

It will be appreciated that embodiments of the invention described in the foregoing are susceptible to being modified without departing from the scope of the invention.

The user 50 and the author 80 are susceptible to co-operating to create assets. For example, templates provided by the author 80 can be merged with data submitted by the user 50 to have the server 20 generate personalised assets for the user 50. Such personalised assets can be cached according to the method of the invention. Beneficially, the server 20 is only required to generate the personalised assets once.

Moreover, expressions such as “comprise”, “include”, “contain”, “incorporate”, “have”, “is” employed in the foregoing to describe and/or claim the present invention are to be construed to be non-exclusive, namely such expressions are to be construed to allow there to be other components or items present which are not explicitly specified. Furthermore, reference to the singular is also to be construed as being a reference to the plural and vice versa.

1. A method of caching data assets in a system (10) comprising at least one server (20) and at least one user device (50), each device (50) including a cache arrangement (120, 130, 140) comprising a plurality of caches (120, 130, 140) for storing requested data assets therein, the method including the steps of:
(a) arranging for one or more data assets to be stored in a first memory of said at least one server (20) and data definitions corresponding to said one or more data assets in a second memory of said at least one server (20);
(b) arranging for said at least one server (20) to be responsive to one or more data requests from said at least one user device (50) by returning to said at least one user device (50) corresponding one or more requested data assets,
wherein said one or more requested-data assets are provided to said at least one user device (50) with associated data definitions for controlling storage and processing of said one or more requested data assets in said at least one user device (50), said at least one server (20) thereby being operable to at least partially control the cache arrangement (120, 130, 140) in said at least one device (50).

2. A method according to claim 1, wherein said plurality of caches (120, 130, 140) in each user device (50) are operable to store both requested assets and their associated definitions.

3. A method according to claim 1, wherein said plurality of caches (120, 130, 140) of said cache arrangement (120, 130, 140) are designated to be of mutually different temporal duration, and said definitions associated with said one or more requested data assets are interpretable within said at least one user device (50) to control storage of said one or more requested data assets in appropriate corresponding said plurality of caches (120, 130, 140).

4. A method according to claim 1, wherein said at least one user device (50) includes:
(a) content managing means (100) for interpreting requests and directing them to said at least one server (20) for enabling said at least one user device (50) to receive corresponding one or more requested data assets; and
(b) cache managing means (110) for directing said one or more requested data assets received from said content managing means (110) to appropriate said plurality of caches (120, 130, 140) depending on said definitions associated with said one or more requested data assets.

5. A method according to claim 1 wherein, for each user device (50), said plurality of caches (120, 130, 140) comprises at least one read-once cache (140) arranged to store one or more requested data assets therein and to subsequently deliver said one or more requested assets a predetermined number of times therefrom after which said one or more requested data assets are deleted from said at least one read-once cache (140).

6. A method according to claim 5, wherein said predetermined number of times corresponds to a single read prior to data asset deletion.

7. A method according to claim 4, wherein each user device (50) further includes interfacing means (200) for interfacing between at least one operator (70) of said at least one user device (50) and at least one of said content managing means (100) and said cache managing means (110), said interfacing means (200):
(a) for conveying asset data requests from the operator (70) to said at least one of said content managing means (100) and said cache managing means (110) for subsequent processing therein; and
(b) for rendering and presenting to said at least one operator (70) said requested data assets retrieved from at least one of said cache arrangement (120, 130, 140) and directly from said at least one server (20).

8. A method according to claim 7, wherein the interfacing means (200) is operable to provide a graphical interface to said at least one operator (70).

9. A method according to claim 7, wherein the interfacing means (200) in combination with at least one of said content managing means (100) and said cache managing means (110) is operable to search said cache arrangement (120, 130, 140) for one or more requested assets before seeking such one or more requested assets from said at least one server (20).

10. A method according to claim 9, wherein said cache arrangement (120, 130, 140) is firstly searched for said one or more requested assets and subsequently said at least one server (20) is searched when said cache arrangement (120, 130, 140) is devoid of said one or more requested assets.

11. A method according to claim 9, wherein the cache arrangement (120, 130, 140) is progressively searched from caches with temporally relatively shorter durations (140) to temporally relatively longer durations (120).

12. A method according to claim 1, wherein said cache arrangement (120, 130, 140) is preloaded with one or more initial data assets at initial start-up of its associated user device (50) to communicate with said at least one server (20), said one or more initial data assets being susceptible to being overwritten when said user device (50) is in communication with said at least one server (20).

13. A method according to claim 1, wherein one or more of the data assets are identified by associated universal resource locators (URL).

14. A method according to claim 1, wherein said system (10) is operable according to first, second and third phases wherein:
(a) the first phase is arranged to provide for data asset entry into said first and second memories (30, 40) of at least one server (20);
(b) the second phase is arranged to provide for content download from said at least one server (20) to said cache arrangement (120, 130, 140) of at least one user device (50); and
(c) the third phase is arranged to provide for content retrieval from at least one of said cache arrangement (120, 130, 140) of said at least one user device (50) and from said at least one server (20).

15. A system (10) for caching data assets, the system (10) comprising at least one server (20) and at least one user device (50), each device (50) including a cache arrangement (120, 130, 140) comprising a plurality of caches (120, 130, 140) for storing requested data assets therein, the system (10) being arranged to be operable:
(a) to store one or more data assets in a first memory of said at least one server (20) and data definitions corresponding to said one or more data assets in a second memory of said at least one server (20);
(b) to arrange for said at least one server (20) to be responsive to one or more data requests from said at least one user device (50) by returning to said at least one user device (50) corresponding one or more requested data assets,
wherein said one or more requested data assets are provided to said at least one user device (50) with associated data definitions for controlling storage and processing of said one or more requested data assets in said at least one user device (50), said at least one server (20) thereby being operable to at least partially control the cache arrangement (120, 130, 140) in said at least one device (50).
